(19) United States
(12) Patent Application Publication
(10) Pub. No.: US 2014/0020921 A1
(43) Pub. Date: Jan. 23, 2014

(54) MECHANICAL IMPACT MECHANISM FOR A HANDHELD POWER TOOL

(71) Applicants: Chuan Cheong Yew, Penang (MY); Cheeuee Neoh, Penang (MY); Daniel Brogli, Campoformido (IT); Chi Hoe Leong, Penang (MY)

(72) Inventors: Chuan Cheong Yew, Penang (MY); Cheeuee Neoh, Penang (MY); Daniel Brogli, Campoformido (IT); Chi Hoe Leong, Penang (MY)

(21) Appl. No.: 13/882,213

(22) PCT Filed: Sep. 30, 2011
(86) PCT No.: PCT/EP2011/067098

§ 371 Date: Oct. 10, 2013

(30) Foreign Application Priority Data
Oct. 28, 2010 (DE) 102010043054.4
Dec. 16, 2010 (DE) 102010063200.7

(51) Int. Cl. B25B 21/02

(52) U.S. Cl. CPC B25B 21/02
USPC 173/93

(57) ABSTRACT

In a handheld power tool having a mechanical impact mechanism which has an impact member provided with at least one drive cam and an output shaft which is provided with at least one output cam and which is connected to a tool receptacle for accommodating a tool, the drive cam being designed for the percussive drive of the output cam during the impact operation of the mechanical impact mechanism, the impact member having the drive cams is mounted upstream from the output cams in an axial direction of the output shaft pointing away from the tool receptacle.

### FIELD

The present invention relates to a handheld power tool having a mechanical impact mechanism which has an impact member provided with at least one drive cam and an output shaft which is provided with at least one output cam and which is connected to a tool receptacle for accommodating a tool, the drive cam being designed for a percussive drive of the output cam during impact operation of the mechanical impact mechanism.

### BACKGROUND INFORMATION

Such a handheld power tool, which is designed as a combi drill and which has a mechanical impact mechanism having an impact member and an output shaft, is described in German Patent Application No. DE 20 2006 014 850 U1. During a non-impact operation of the combi drill, drive cams, which are implemented on the impact member, mesh with the output cams, which are provided on the output shaft, in such a way that a rotary motion of the impact member is transferred to the output shaft. During impact operation of the combi drill or the impact mechanism, the drive cams drive the output cams in an assigned direction of rotation in a percussive manner, each drive cam hitting against an assigned output cam in a hammer-like manner during a corresponding impact generation.

A disadvantage is that the impact generation during impact operation of the impact mechanism results, on the one hand, in vibrations of the handheld power tool and, on the other hand, in an undesirable noise generation and thus in comfort losses when using such a handheld power tool.

### SUMMARY

An object of the present invention is to provide a novel handheld power tool which has a mechanical impact mechanism which enables at least a reduction of the noise generation during impact operation.

This object is achieved by a handheld power tool having a mechanical impact mechanism which has an impact member provided with at least one drive cam and an output shaft which is provided with at least one output cam and which is connected to a tool receptacle for accommodating a tool. The drive cam is designed for a percussive drive of the output cam during impact operation of the mechanical impact mechanism. The impact member having the drive cams is mounted upstream from the output cams in an axial direction of the output shaft pointing away from the tool receptacle.

The present invention thus makes it possible to provide a handheld power tool having a mechanical impact mechanism in which at least a reduction of the vibrations of the handheld power tool, which are generated during the impact generation, is made possible by an impact generation in the axial direction pointing away from the tool receptacle, i.e., in the direction of a gear or drive motor provided for driving the output shaft.

The output shaft is preferably drivable by a pot-like drive body which encloses the output shaft at least sectionally and forms a hollow space in which the impact member is axially displaceably situated on the output shaft.

Thus, an impact generation may take place within a pot-like drive body which is thus used as a damping element for noise reduction during the impact generation.

According to one specific embodiment, the impact member is acted on in the direction of the output cams by a spring element situated in the hollow space. The direction of the output cams corresponds to an axial direction of the output shaft pointing away from the tool receptacle.

In this way, it is possible in a simple manner to enable an impact generation in an impact position spaced apart from the tool receptacle by a predefined distance.

The spring element is preferably a pressure spring.

In this way, a stable and cost-effective spring element may be provided.

A gear for driving a drive element is preferably provided which is rotatably fixedly connected to the drive body.

In this way, the drive body may be driven safely and reliably via the drive element.

According to one specific embodiment, the gear is designed as a planetary gear, a planet carrier of the planetary gear forming the drive element.

In this way, an uncomplicated and robust gear may be provided.

The impact member is preferably supported on the drive body by at least one steel ball.

In this way, an axial displacement of the impact member within the drive body may be made possible in a simple manner with the aid of the steel ball.

The drive body preferably has an inner wall on which at least one groove-like recess is formed for guiding the at least one steel ball.

In this way, a safe and reliable guidance of the steel ball is enabled on the inner wall of the drive body.

The impact member preferably has an outer wall on which at least one recess is formed for accommodating the at least one steel ball.

In this way, a reliable accommodation of the steel ball on the impact member is enabled.

According to one specific embodiment, the at least one steel ball is movable in the groove-like recess of the drive body and the recess of the impact member during impact operation of the mechanical impact mechanism to enable a twisting of the impact member in relation to the output shaft and in relation to the drive body.

In this way, a twisting of the impact member may be enabled in a simple manner in relation to the output shaft and in relation to the drive body.

The object mentioned at the outset is also achieved by a mechanical impact mechanism for a handheld power tool having an impact member provided with at least one drive cam and an output shaft which is provided with at least one output cam and which is connected to a tool receptacle for accommodating a tool. The drive cam is designed for a percussive drive of the output cam during impact operation of the mechanical impact mechanism. The impact member having the drive cams is mounted upstream from the output cams in an axial direction of the output shaft pointing away from the tool receptacle.

### BRIEF DESCRIPTION OF THE DRAWINGS

The present invention is explained in greater detail below with reference to the exemplary embodiments shown in the figures.

FIG. 1 shows a schematic view of a handheld power tool having an insert tool according to one specific embodiment.

FIG. 2 shows an enlarged sectional view of a detail of the handheld power tool from FIG. 1.

FIG. 3 shows a perspective view of the drive body from FIGS. 1 and 2.

FIG. 4 shows a perspective view of the output shaft from FIGS. 1 and 2.

FIG. 5 shows a perspective view of the impact member from FIGS. 1 and 2.

FIG. 6 shows a perspective view of the output shaft from FIGS. 1 and 2 which is mounted on the gear housing from FIG. 2 and on which the impact member, the spring element, and the steel ball from FIG. 2 are situated.

### DETAILED DESCRIPTION OF EXAMPLE EMBODIMENTS

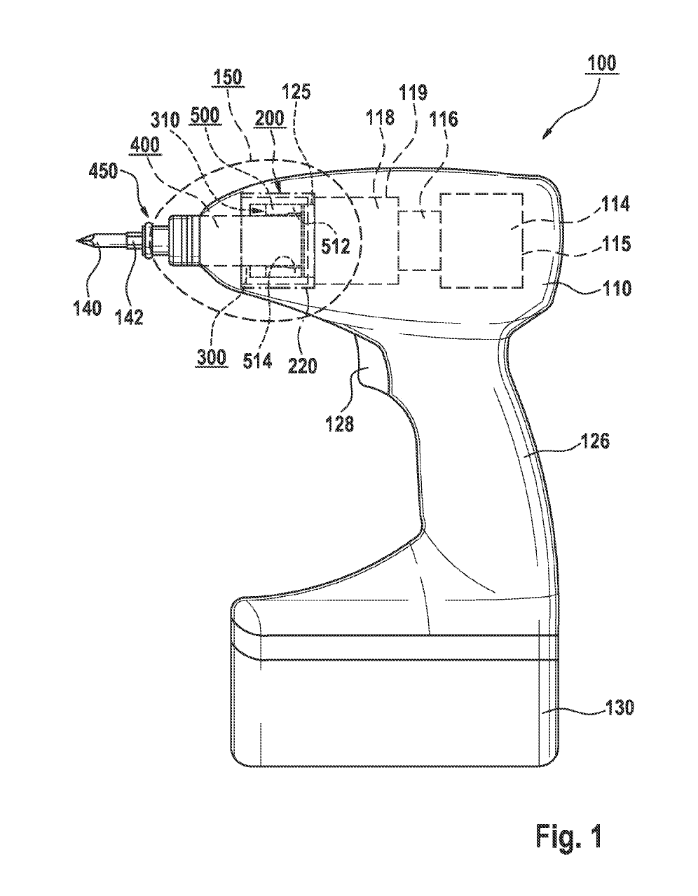

FIG. 1 shows a handheld power tool 100 which is provided with a tool receptacle 450 and a mechanical impact mechanism 200 and which has a housing 110 including a handle 126. According to one specific embodiment, handheld power tool 100 is connectable mechanically and electrically to a battery pack 130 for a cordless power supply.

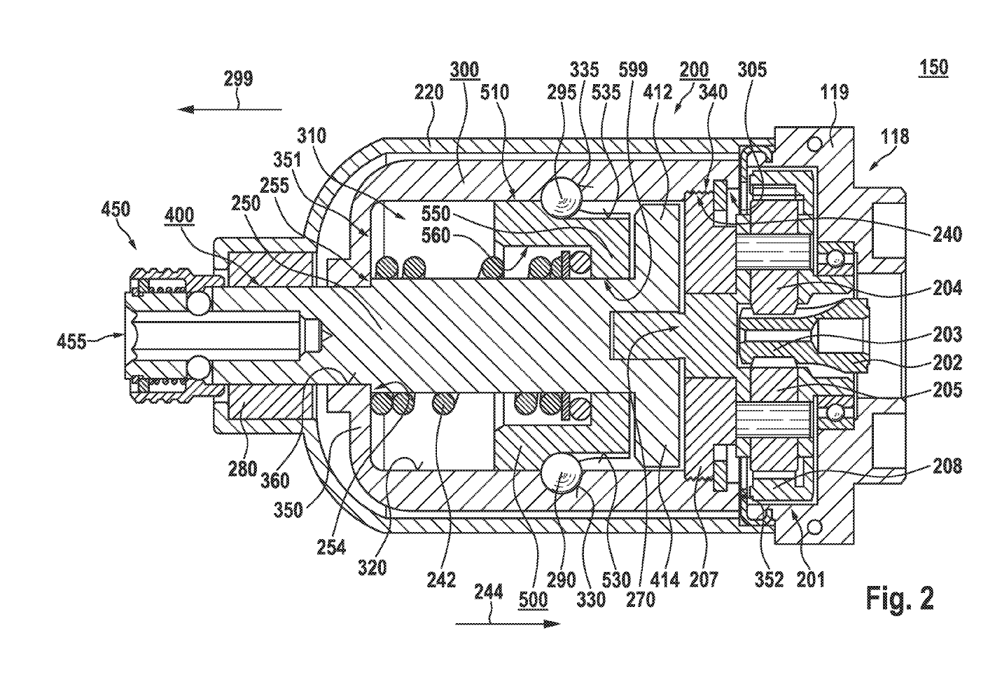

Handheld power tool 100 is designed as a cordless combi drill, as an example. However, the present invention is not limited to cordless combi drills, but may rather be used in various power tools in which a tool is set into rotation, e.g., in the case of a percussion drill, etc., regardless of whether the power tool is mains-operated or operable cordlessly using a battery pack. Moreover, the present invention is not limited to motor-operated handheld power tools, but may be used in general in tools in which impact mechanism 200 described in FIGS. 2 through 6 may be used.

An electric drive motor 114, which is supplied with power by battery pack 130, a gear 118, and impact mechanism 200 are situated in housing 110. Drive motor 114 is, for example, operable via a manual switch 128, i.e., switchable on and off, and may be any type of motor, e.g., an electronically commutated motor or a DC motor. Preferably, drive motor 114 is electronically controllable in such a way that a reverse operation as well as inputs with regard to a desired rotational speed are implementable. The mode of operation and the design of a suitable drive motor are not described here in greater detail for the sake of a concise description.

Drive motor 114 is connected via an associated motor shaft 116 to gear 118 which converts a rotation of motor shaft 116 into a rotation of drive element 125. This conversion preferably takes place in such a way that drive element 125 rotates in relation to motor shaft 116 at an increased torque but at a reduced rotational speed. Drive motor 114 is illustratively situated in a motor housing 115, and gear 118 is illustratively situated in a gear housing 119, gear housing 119 and motor housing 115 being situated in housing 110 as an example.

Mechanical impact mechanism 200 connected to drive element 125 is a rotary impact mechanism, as an example, which is situated in an illustrative impact mechanism housing 220 and has an impact member 500 which executes impact-like angular momentums via associated drive cams 512, 514 with great intensity and transfers them to an output shaft 400, e.g., an output spindle. It is, however, pointed out that the use of impact mechanism housing 220 is an example only and does not pose any limitations to the present invention. It may in fact be used with impact mechanisms without a separate impact mechanism housing which are situated directly in housing 110 of handheld power tool 100, for example. An exemplary design of impact mechanism 200 is described in conjunction with a detail 150 of handheld power tool 100 shown in FIG. 2.

Tool receptacle 450, which is preferably designed to accommodate insert tools and is connectable to an insert tool 140 having an external polygonal coupling 142, is illustratively provided on output shaft 400. Additionally or alternatively, tool receptacle 450 may also be connectable to an insert tool having an internal polygonal coupling, e.g., a socket wrench, according to one specific embodiment. As an example, insert tool 140 is designed as a screwdriver bit having external polygonal coupling 142, illustratively an octagonal coupling, which is situated in an appropriate inner receptacle (455 in FIG. 2) of tool receptacle 450. Such a screwdriver bit as well as a suitable socket wrench are sufficiently known from the related art so that a detailed description thereof is dispensed with for the sake of a concise description.

FIG. 2 shows detail 150 from FIG. 1, including gear 118 situated in gear housing 119 and mechanical impact mechanism 200 from FIG. 1 which is in operative connection with output shaft 400 and has impact mechanism housing 220. As described in FIG. 1, mechanical impact mechanism 200 has drive body 300 which is connected to drive element 125 of gear 118 and which is situated in impact mechanism housing 220 together with impact member 500.

Output shaft 400 has, as an example, a shaft body 250 which is provided with an annular shoulder 255 and on which at least one and illustratively two output cams 412, 414 are formed, as well as tool receptacle 450 from FIG. 1 which is provided with an octagonal inner receptacle 455, for example. An axial end of shaft body 250, on which output cams 412, 414 are provided, is illustratively connected to a bearing part 270. According to one specific embodiment, output shaft 400 is rotatably mounted in impact mechanism housing 220 via a sliding bearing 280 and in gear housing 119 via bearing part 270. Gear housing 119 and impact mechanism housing 220 are illustratively fastened to one another.

According to one specific embodiment, gear 118 is a reduction gear unit which is, for example, designed in the form of a planetary gear and has one or multiple planetary stages. Illustratively, planetary gear 118 has one single planetary stage 201 having a sunwheel 203, planetary wheels 204, 205, an annulus gear 208, and a planet carrier 207 which forms drive element 125 from FIG. 1, as an example, and is rotatably fixedly connected thereto for rotatingly driving drive body 300. Sunwheel 203 is drivable by a drive element 202 which is rotatably fixedly connected to motor shaft 116 or which may be integrally connected to it or may be designed in one piece with it, for example. Sunwheel 203 and drive element 202 are preferably also designed in one piece. A further description of planetary gear 118 is dispensed with for the sake of a concise description.

Planet carrier 207 illustratively has a fastening device 240 for rotatably fixedly fastening planet carrier 207 to drive body 300. Drive body 300 has a counter fastening device 340, as an example, which is operatively linked to fastening device 240. Fastening device 240 and counter fastening device 340 together form a press-fit connection, for example. However, other types of connections are also possible, e.g., clamping, latching, or tooth-gap connections are also possible which enable a rotatably fixed connection between planet carrier 207 and drive body 300.

Drive body 300 is designed in the shape of a pot, as an example, and has a pot bottom-like wall 350, which is provided with an opening 360, on a first axial end 351. This opening 360 illustratively forms an annular collar 254. On its opposite axial end 352, pot-like drive body 300 has an opening 305 on which counter fastening device 340 is formed.

According to one specific embodiment, drive body 300 encloses output shaft 400 at least sectionally. Illustratively, pot-like drive body 300 has an inner wall 320 and forms a hollow space 310 in which shaft body 250 is situated together with the two output cams 412, 414 of output shaft 400 up to annular shoulder 255 provided there, so that output shaft 400 is situated rotatably, but axially immovably, in drive body 300.

Here, annular shoulder 255 rests, as an example, against annular collar 254 formed on drive body 300. Moreover, impact member 500 is situated rotatably and axially displaceably, as an example, within hollow space 310 on output shaft 400.

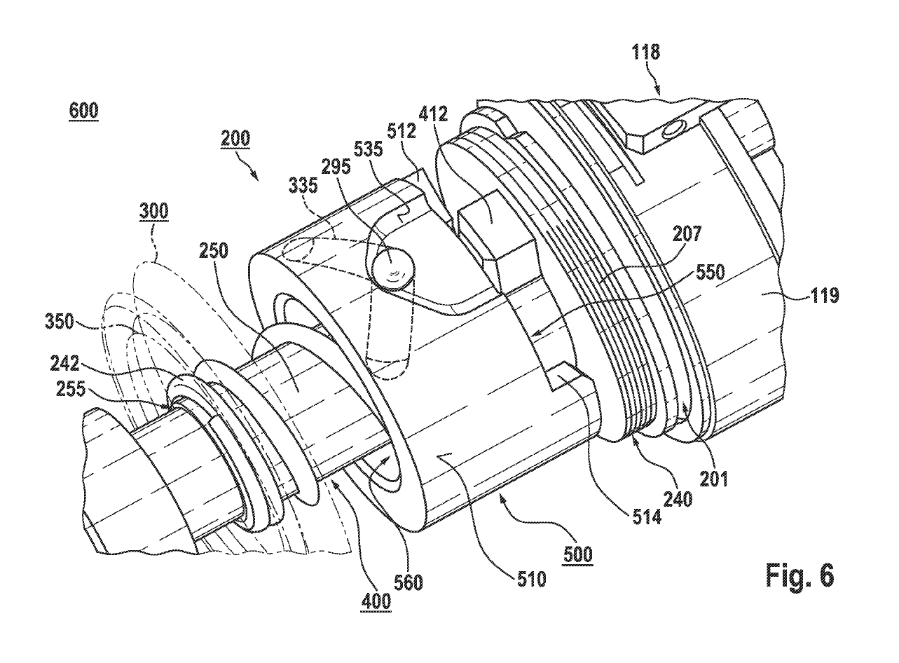

Impact member 500 is designed in the shape of a pot, as an example, and has an outer wall 510 and a bottom wall 550 which form an inner chamber 560. An opening 599 is formed in bottom wall 550 through which shaft body 250 of output shaft 400 engages. Impact member 500 is acted on by a spring element 242, which is also situated in hollow space 310, in the direction of output cams 412, 414. This direction of output cams 412, 414 corresponds to an axial direction of output shaft 400 which points away from tool receptacle 450 and which is denoted with reference numeral 244, as an example. For this purpose, spring element 242 designed as a pressure spring, for example, is preferably situated between annular collar 254 or pot bottom-like wall 350 of drive body 300 and bottom wall 550 of impact member 500, spring element 242 engaging through inner chamber 560 of impact member 500, as illustrated in FIG. 6.

It is, however, pointed out that according to the present invention impact member 500 is acted on by spring element 242 in direction 244, i.e., in a direction which is axially opposed during operation to a corresponding forward direction of handheld power tool 100 from FIG. 1. This forward direction is denoted in FIG. 2 with reference numeral 299, as an example.

According to one specific embodiment, impact member 500 is supported on drive body 300 by at least one driving ball. Impact member 500 is illustratively supported on drive body 300 via two steel balls 290, 295. For this purpose, on inner wall 320 of drive body 300, at least one groove-like recess is formed for guiding the at least one driving ball. Illustratively, a preferably V-shaped groove-like recess 330 is provided for guiding steel ball 290 and a preferably V-shaped groove-like recess 335 is provided for guiding steel ball 295 which are referred to in the following as “V grooves.” On outer wall 510 of impact member 500, at least one indentation or recess is formed for accommodating the at least one driving ball. Illustratively, an indentation or a recess 530 is formed for accommodating steel ball 290 and an indentation or recess 535 is formed for accommodating steel ball 295. Steel balls 290, 295 are movable in V grooves 330, 335 and indentations or recesses 530, 535 during impact operation of mechanical impact mechanism 200 in order to allow impact member 500 to twist in relation to output shaft 400 and in relation to drive body 300, as described below.

During normal operation of handheld power tool 100 from FIG. 1, planet carrier 207 forming drive element 125 from FIG. 1 rotatably drives pot-like drive body 300. Via steel balls 290, 295, drive body 300 drives impact member 500 whose drive cams (512, 514 in FIGS. 1, 5 and 6) rest against output cams 412, 414 of output shaft 400, so that impact member 500 also sets output shaft 400 into rotation. In this way, a rotary motion of planet carrier 207 is transferred to output shaft 400 via drive body 300, steel balls 290, 295, and impact member 500 during impact-free operation or normal operation of handheld power tool 100 from FIG. 1.

Now, if the torque request on output shaft 400 is suddenly increased and its rotary motion is thus blocked, mechanical impact mechanism 200 transitions into a corresponding impact operation in which drive body 300 is continuously rotated by planet carrier 207. Here, steel balls 290, 295 are moved in V grooves 330, 335 so that impact member 500 is pressed in forward direction 299 against a corresponding restoring force of spring element 242, so that drive cams (512, 514 in FIGS. 1, 5 and 6) slide away via output cams 412, 414 and are subsequently accelerated at a comparably great torque against output cams 414 and 412, and carry out a rotary impact against them.

During the reverse operation of handheld power tool 100 from FIG. 1, the normal operation and the impact operation take place in a similar manner, so that a detailed description of the reverse operation is dispensed with here for the sake of a concise description. Moreover, it is pointed out that the mode of operation of a V-groove rotary impact mechanism is known in principle from the related art, so that a more detailed description of the mode of operation of impact mechanism 200 is also dispensed with here.

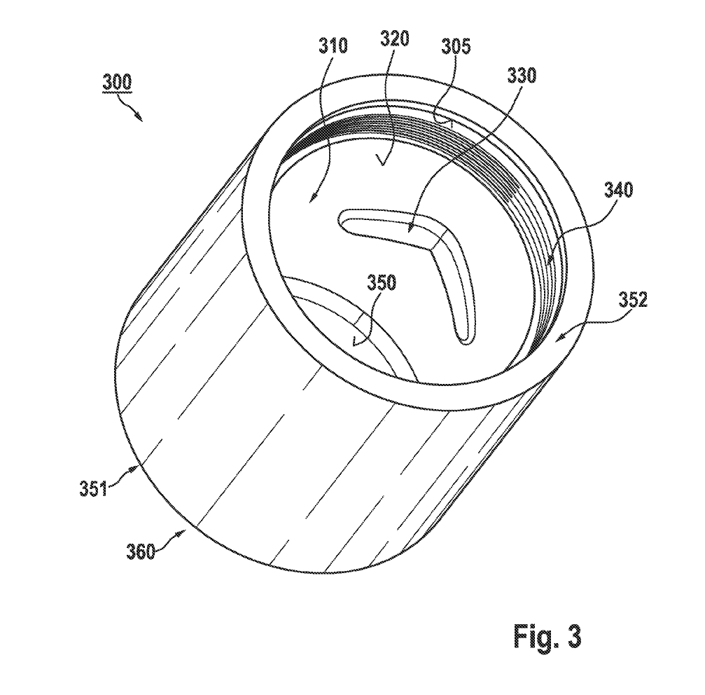

FIG. 3 shows drive body 300 from FIG. 2 which is designed in the shape of a pot and has an opening 305 formed on axial end 352, and which has a pot bottom-like wall 350 formed on opposite axial end 351 and provided with opening 360. FIG. 3 illustrates V groove 330 formed on inner wall 320 as well as counter fastening device 340 provided in the area of opening 305.

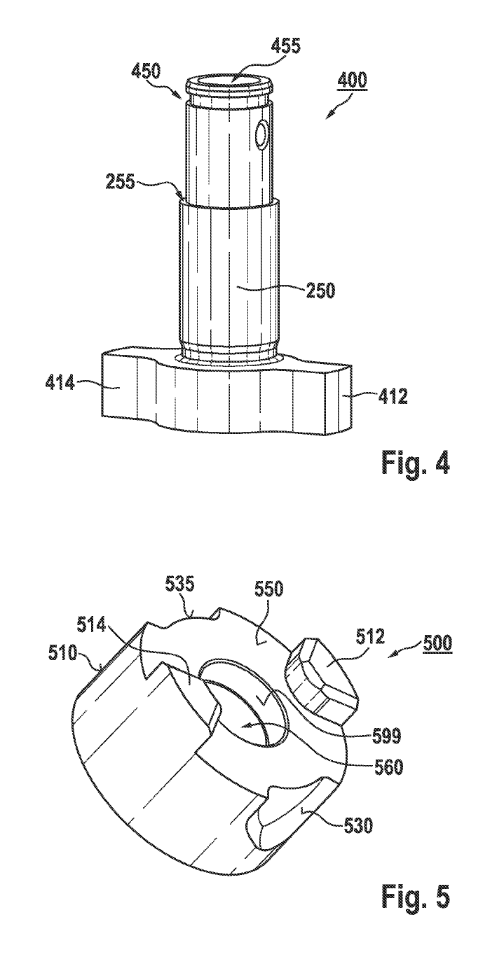

FIG. 4 shows output shaft 400 from FIG. 2 having shaft body 250 and tool receptacle 450 designed as an octagonal inner receptacle 455, as an example. FIG. 4 illustrates exemplary lateral output cams 412, 414, which are formed on output shaft 400, as well as annular shoulder 255. Output cams 412, 414 are integrally connected to output shaft 400 as essentially rectangular, radial extensions, as an example, and are thus connected to it as one piece and illustratively have rounded outer corners.

FIG. 5 shows impact member 500 from FIG. 2 having exemplary drive cams 512, 514 from FIG. 1. These are preferably formed on impact member 500, e.g., integrally connected to it, and are thus connected to impact member 500 as one piece. Illustratively, drive cams 512, 514 are designed as prism-like projections having approximately trapeze-shaped base areas which are oriented in the axial direction of impact member 500 and whose radially inner and outer sides, which are oriented in parallel to one another, are slightly rounded for adaptation to the outer periphery of cylinder-shaped impact member 500. According to one specific embodiment, drive cams 512, 514 are designed, as described above, for the percussive drive of output cams 412, 414 of output shaft 400 from FIG. 4 during impact operation of handheld power tool 100 from FIG. 1 or mechanical impact mechanism 200 from FIG. 2.

Furthermore, FIG. 5 illustrates an exemplary embodiment of recesses 530, 535. They illustratively have a cross section provided with rounded corners and a housing-like cross section.

FIG. 6 shows impact mechanism 200 and gear 118 from FIG. 2 without impact mechanism housing 220 from FIG. 2. Pot-like drive body 300 is illustrated only sectionally in a transparent representation having its pot bottom-like wall 350 and V groove 335 in order to illustrate a cooperation between V groove 335, steel ball 295, and recess 535, as an example.

Furthermore, FIG. 6 illustrates an inner chamber 560 of impact member 500 against whose bottom wall 550 spring element 242 is supported all the way through to act on impact member 500 in the direction of gear 118. Moreover, FIG. 6 illustrates annular shoulder 255 implemented on shaft body 250 of output shaft 400.

1-11. (canceled)

12. A handheld power tool, comprising:
a mechanical impact mechanism which includes an impact member provided with at least one drive cam, and an output shaft which is provided with at least one output cam and which is connected to a tool receptacle for accommodating a tool, the drive cam being configured for percussively driving the output cam during impact operation of the mechanical impact mechanism;
wherein the impact member is mounted upstream from the output cam in an axial direction of the output shaft pointing away from the tool receptacle.

13. The handheld power tool as recited in claim 12, wherein the output shaft is drivable by a pot-like drive body which encloses the output shaft at least sectionally and forms a hollow space in which the impact member is axially displaceably situated on the output shaft.

14. The handheld power tool as recited in claim 13, wherein the impact member is acted on in the direction of the output cam by a spring element situated in the hollow space, the direction of the output cam corresponding to the axial direction of the output shaft pointing away from the tool receptacle.

15. The handheld power tool as recited in claim 13, wherein the spring element is a pressure spring.

16. The handheld power tool as recited in claim 12, further comprising:
a gear to drive a drive element, the gear being rotatably fixedly connected to the drive body.

17. The handheld power tool as recited in claim 16, wherein the gear is a planetary gear, a planet carrier of the planetary gear forming the drive element.

18. The handheld power tool as recited in claim 12, wherein the impact member is supported on the drive body via at least one steel ball.

19. The handheld power tool as recited in claim 18, wherein the drive body has an inner wall on which at least one groove-like recess is formed for guiding the at least one steel ball.

20. The handheld power tool as recited in claim 19, wherein the impact member has an outer wall on which at least one recess is formed for accommodating the at least one steel ball.

21. The handheld power tool as recited in claim 20, wherein the at least one steel ball is movable in the groove-like recess of the drive body and the recess of the impact member during impact operation of the mechanical impact mechanism to enable a twisting of the impact member in relation to the output shaft and in relation to the drive body.

22. A mechanical impact mechanism for a handheld power tool having an impact member provided with at least one drive cam and an output shaft which is provided with at least one output cam and which is connected to a tool receptacle for accommodating a tool, the drive cam being configured for percussively driving the output cam during impact operation of the mechanical impact mechanism, wherein the impact member having the drive cams is mounted upstream from the output cams in an axial direction of the output shaft pointing away from the tool receptacle.
